(19) United States
(12) Patent Application Publication
(10) Pub. No.: US 2008/0238089 A1
(43) Pub. Date: Oct. 2, 2008

(54) Coupling device for a fluid line

(75) Inventors: Ulrich Kees, Homburg (DE); Harald Rohrig, Spiesen-Elversberg (DE)

Correspondence Address: HOFFMANN & BARON, LLP, 6900 JERICHO TURNPIKE, SYOSSET, NY, 11791, US

(73) Assignee: Festo AG & Co

(21) Appl. No.: 12/075,088

(22) Filed: Mar. 7, 2008

(30) Foreign Application Priority Data
Mar. 30, 2007 (DE) 10 2007 015 407.2

(51) Int. Cl. F16L 55/00

(52) U.S. Cl. 285/86

(57) ABSTRACT

A coupling device for a fluid line has a collet able to be operated by an actuating sleeve. The collet possesses an annular base portion with support arms extending axially from it, on which two gripping teeth are arranged which are axially spaced apart least in part. Each gripping tooth is provided individually with its own actuating portion to be acted on by actuating faces on the actuating sleeve to cause a clamping operation.

### FIELD OF THE INVENTION

The invention relates to a coupling device for a fluid line comprising a sleeve-like collet bearing against a main body axially and into which a fluid line to be coupled may be coaxially inserted and which has a plurality of axially extending support arms, distributed in the peripheral direction, of which at least some bear at least two axially spaced radially inwardly extending gripping teeth, which on axial shifting of a actuating sleeve arranged around the collet may be thrust radially inward to perform a coupling operation in order to be braced against the outer periphery of the inserted fluid line.

### BACKGROUND OF THE INVENTION

A coupling device disclosed in the European patent publication EP 1 038 138 of this type has a collet with a meandering configuration, whose axially extending support arms have radially inwardly projecting gripping teeth at each end. It is in this manner that the collet is provided with two groups of axially spaced gripping teeth. On the inner periphery of the actuating sleeve encircling the collet there are actuating faces defined by an annular face which on axial shifting, starting at a non-actuated position, of the actuating sleeve act on actuating portions arranged on the support arms between the two tooth groups and accordingly thrust the gripping teeth inward so that they are braced against the outer periphery of a previously inserted fluid line. At has turned out although the known coupling device works satisfactorily, it involves exacting requirements as regards the technology of manufacture of the collets, so that the product becomes expensive.

Accordingly there has already been a proposal in the German patent publication 10058967 A1 for a two part design of the collets, each of the interfitting collet elements having one of the tooth groups. In this case however more particularly maintaining the correct relative position between the two collet elements raises problems.

In the European patent publication EP 0811801 there has been a proposal to use a simple thrust ring as a collet, which is slotted from opposite sides in an alternating manner at the end. In this case however an additional active cooperation is required between the thrust ring and the main body in order to radially deform the gripping teeth of both tooth groups.

In the case of a plugged fitting described in the German patent publication DE 40 02 057 A1 the clamping of the collet arms is caused by axial displacement of the collet in relation to an actuating sleeve positioned stationarily on the main body. The collet possesses an annular base portion from which several support arms extend, which at the end have a head portion, on which two axially spaced gripping teeth are arranged. On shifting the collet the actuating sleeve thrusts against the head pieces and pushes the two gripping teeth arranged thereon jointly inward. Mutually independent movements between gripping teeth on one and the same head portion are not possible.

Finally the German patent publication DE 10 2005 017 692 B3 discloses a coupling device whose gripping teeth are arranged on a metallic cage element in the form of a bent and stamped component. The coupling operation is in this case due to the build up of a return force, when the gripping teeth are spread apart on insertion of fluid line. For release of the fluid line a release sleeve is thrust against the gripping teeth so that same are moved clear of the outer periphery of the fluid line. Apart from the fact that in this case only one group of teeth is present, in the case of this coupling device there is no active driving action on the gripping teeth for clamping the fluid line. If consequently the fluid lines have irregular dimensions failure to keep to the specified diameter in conjunction with heavy loads may mean that the fluid line is not always reliably held.

### SUMMARY OF THE INVENTION

One object of the present invention is to create a coupling device of the type initially mentioned allowing rational manufacture and at the same time a secure attachment of the fluid lines to be connected.

In order to achieve this aim there is the provision that the collet possesses an annular base portion from which all support arms extend in the same axial direction, all gripping teeth being spaced axially from and in front of the base portion, and each gripping tooth on the collet being provided with its own actuating portion individually, on which the actuating sleeve may act during its axial shifting movement to cause the respective coupling action of the respective gripping tooth, the actuating sleeve for operation of the actuating portions of axially spaced apart gripping teeth being provided with actuating faces arranged at an axial distance apart.

Accordingly two axially spaced apart gripping teeth are present on at least some and preferably all support arms so that the fluid line is restrained not only in a single restricted area but at several axially spaced apart positions, something which promises a greater resistance of the fluid line to being pulled out. Owing to the actuating sleeve the gripping teeth are actively braced on the fluid line so that there are no relaxation problems. Since each gripping tooth on the collet has its own individual actuating portion, gripping teeth arranged on the same support arm may be braced on the fluid line independently of each other, this meaning that a more secure hold is offered. Even if a gripping tooth should only exert a small bracing force on the fluid line for some reason, the other gripping teeth may be fully effective. For the actuation of axially spaced gripping teeth the actuating sleeve is provided with axially spaced actuating faces so that a purposeful cooperation with the actuating portions is ensured.

Further advantageous developments of the invention are defined in the dependent claims.

It is an advantage for each gripping tooth to be joined in a radially resilient manner by way of its own individual connection portion on the associated support arm. The support arm can then be relatively stiff in design and for its part will not necessarily require to be able to be radially swung to ensure the mobility of the gripping teeth. In the case of such a design the actuating portions are preferably formed by the mounting portions directly which are so designed that they project radially out beyond the support arms.

In order to releasably lock the actuating sleeve in the operated condition causing the bracing action of the gripping teeth, mutually cooperating detent means may be provided on the collet and on the actuating sleeve. It is an advantage in this connection if the actuating portions on the collet extend at an angle with a radially outwardly orientated ridge portion, f. i. with a V-shaped configuration, which in the actuated state of the actuating sleeve fits into detent socket formed on the inner periphery thereof. In this case it suffices for only a few actuating portions to participate in the detent function.

The collet is preferably so arranged on the main body that its support arms, starting at the base portion, extend outward axially in a direction opposite to the direction of insertion. This facilitates the support of the collet in relation to the main body, if for example only the base portion of the collet has to be secured to the main body.

An optimum compromise between the complexity of manufacture and the reliability of holding the fluid line has been found to be an arrangement in which each of the support arms present bears at least two axially spaced gripping teeth. In principle however the design might be limited to having several gripping teeth on only some support arms, although there is the possibility of providing more than two gripping teeth per support arm.

If the gripping teeth arranged on the same support arm are arranged with a mutual offset in the peripheral direction of the collet there is then an even distribution of the points of engagement of the gripping teeth along the outer periphery of the inserted fluid line. Furthermore in this case any local damage to the outer face of the fluid line will have a less serious effect on the firmness of the clamping connection.

A configuration has turned out to be particularly advantageous in which a front gripping tooth is arranged on one or more support arms as an axial extension of the support arm, while at least one further gripping tooth is laterally seated on the support arm with an axial separation from it. The laterally arranged support arm may in particular be secured on the support arm using a connecting rib extending in the peripheral direction of the collet. This design is particularly advantageous for manufacture of the collet as a stamped and bent component of metal.

In particular the gripping teeth arranged on the different support arms could be arranged at different axial distances from the base portion with practically any desired distribution. However an arrangement is considered to be particularly advantageous in which the gripping teeth of all support arms constitute at least two and preferably just two tooth groups arranged at different distances from the base portion, all gripping teeth belonging to the same tooth group and preferably furthermore the actuating portions belonging to them are arranged at the same distance from the actuating portion.

Owing to the multiple arrangement of gripping teeth on one or all support arms there is normally a greater actuating force for the actuating sleeve. In order to oppose it the distance apart of the actuating portions respectively arranged in pairs and actuating faces may be different, as considered in the non-actuated state of the actuating sleeve.

The result of this is that on shifting the actuating sleeve at least some of the actuating portions are acted on by the actuating sleeve in sequence. Accordingly for instance the actuating force for one gripping tooth only has to be applied after the actuating force for another gripping tooth has already been applied for the most part. This timed actuation in sequence may apply for only some or all of the gripping teeth. In conjunction with several axially spaced tooth groups the arrangement will more particularly be so designed that the gripping teeth in different groups are operated in sequence whereas the teeth in the same group are simultaneously actuated.

In all cases it is an advantage if each actuating portion is provided with its own actuating face on the actuating sleeve. The respective machining of the inner periphery of the actuating sleeve may consequently be minimized.

In this respect it is an advantage if periphery of the actuating sleeve has an axially extending guide groove in it for each actuating portion, along which the associated actuating portion slides on shifting the actuating sleeve. The floor of the individual guide grooves may in this case constitute the actuating face, for example in the form of a sloping face portion of the same. The engagement of the actuating portions in the guide grooves may offer the advantage of preventing twisting of the actuating sleeve out of position too.

The main body may for example be the wall of a fluid power device, f. i. of a valve or a fluid power drive. A separate housing body to receive the collet is accordingly unnecessary. There is also the possibility however of designing the main body as an individual component on its own, which is provided with attachment means such as a mounting screw thread, which renders possible attachment to a specially provided interface for a fluid power device. The main body may in this case readily be made in several parts, as for example in order to allow tilting.

In the following the invention will be explained in detail with reference to the accompanying drawings.

### BRIEF DESCRIPTION OF THE DRAWINGS

FIG. 1 shows a preferred embodiment of the coupling device of the invention in a longitudinal section whose plane is indicated by the section line I-I in FIGS. 4 and 8, a fluid line inserted for connection being indicated in chained lines and the actuating sleeve being depicted in the non-actuated state.

FIG. 2 is a perspective, separate view of the collet employed in the coupling device of FIG. 1 as seen from the rear.

FIG. 3 shows the collet of FIG. 2 in a perspective elevation as viewed from the front side. [00271 FIG. 4 is a front view of the collet looking in the direction of the arrow IV in FIG. 3.

FIG. 5 is a longitudinal section taken through the collet on the section line V-V of FIG. 4.

FIG. 6 is a plan view of the stamped and bent component employed in the manufacture of the collet prior to bending.

FIG. 7 is a separate perspective view of the actuating sleeve looking into the interior thereof from the side of the collet.

FIG. 8 is an end-on view of the actuating sleeve as seen from the collet side and looking in the direction of the arrow VIII in FIG. 7.

FIG. 9 is a longitudinal section taken through the actuating sleeve on the section line IX-IX in FIG. 8.

### DETAILED DESCRIPTION OF THE PREFERRED EMBODIMENTS

The coupling device generally referenced 10 comprises a main body 1 in which a socket 2 opening at an outer face and preferably with a circular cross section is formed which preferably coaxially is adjoined by a fluid line 3 extending in the main body 1. In the socket 2 a collet 4 with a sleeve-like configuration us placed and at least a part of its length is coaxially received in the socket. An actuating sleeve 5, which is coaxial in relation to the collet 4, encircles the collet 7 and in relation to the same and to the main body 1 is able to be shifted with a movement 6 indicated by a double arrow. The displacement direction extends axially, i. e. in the direction of the common longitudinal axis 7 of the socket 2, of the collet 4 and of the actuating sleeve 5.

A fluid line 12, indicated in chained lines, is introduced into the socket 2 through the actuating sleeve 5 and the collet 4 and it may be restrained in the inserted state by the collet 4. The fluid duct 13 formed in it communicates in the inserted state with the fluid duct 3 in the main body 1 so that to this extent there is now a fluid connection.

The coupling device 10 may be designed as an independent subassembly, whose main body 1 is able to be secured by an attachment portion 14 to a fluid power device 15, as for example a fluid operated drive or a valve, which is only depicted in part. The attachment portion 14 is for example a screw threaded spigot, which is able to be screwed into a connection opening 16 with a female thread in the fluid power device 15 in order to produce a connection of the fluid duct 3 with the device duct belonging to the connection opening 16. As an alternative to this the attachment portion 14 might for example also be designed for assembly by plugging or by producing a press fit. Though in the present example it is located on the rear side of the main body 1 opposite to the socket 2, it could for example also be constituted by the portion containing the socket 2 so that the main body 1 is able to be retracted in a connection opening 16 provided for it, at least for the greater part of its length.

The main body 1 may furthermore be of multi-part design, for example to constitute a pivoting screw arrangement. The attachment portion 14 would then be located on a first part of the main body 1, on which a second main body part having the socket 2 is arranged in a pivoting fashion.

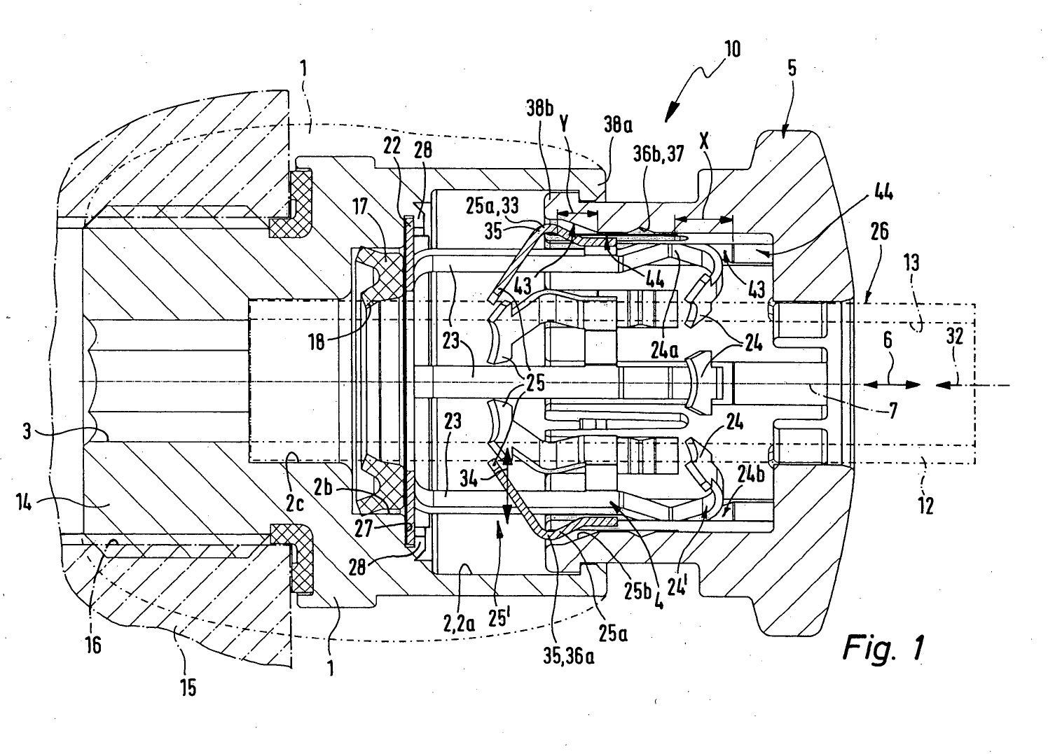

In the case of a further embodiment, which is indicated in chained lines in FIG. 1, the main body is constituted directly by the wall of a fluid power device so that it is possible to do without any additional and independent main body.

The fluid line 12 to be connected may be a flexible hose or also a rigid pipe of plastic material or of metal.

The socket 2 possesses an axially external receiving portion 2a in which the collet 4 is secured, preferably in a manner precluding axial movement. In an axially inward direction it is adjoined by a further receiving portion 2b with a reduced diameter, which receives an annular receiving portion 2b with a reduced diameter which has an annular seal 17 in it, preferably a so-called groove ring. The seal 17 makes sealing contact with the outer periphery of the inserted fluid line, preferably at a radially resilient sealing lip 18 which is in a position to allow for even large inaccuracies in diameter of the fluid line 12. In other respects the seal 17 furthermore makes sealing contact with the main body 1 so that leakage of fluid is not possible.

It is to be noted at this point that the coupling device 10 may be connected both with fluid lines 12 for liquid media and also for gaseous fluids, more particularly compressed air.

The further receiving portion 2b is axially adjoined by a receiving portion 2c with a reduced diameter which simultaneously may function as a centering portion since it receives the front end portion of the inserted fluid line 12. Its diameter may more particularly be the same as that of the outer face of the fluid line 12.

At one end the collet 4 preferably has an annular and preferably disk-like flat base portion 22, from which support arms 23 extend in the same axial direction along the periphery of the collet 4 with arms 23 distributed and spaced apart along the periphery of the collet 4. Apart from their base portion 22 the support arms 22 are not joined together and more particularly do not bear against each other. This provides for a mutually independent flexibility in the radial direction in relation to the longitudinal axis 7.

The support arms 23 bear, with an axial clearance from the base portion 22, radially inwardly extending gripping teeth 24 and 25. They are designed to be braced against the outer periphery 26 of the inserted fluid line 12 to avoid its being pulled out by accident.

The collet 4 is introduced into the socket 2 with its base portion 22 to the fore and bears at such base portion 22 in an axial direction against the main body 1. Preferably the collet 4 is furthermore axially fixed in position in relation to the main body 1 in an immovable fashion, the corresponding fixation occurring at the base portion 22. The base portion bears in the present example against the annular floor face 27 of the further receiving portion 2b encircling the further receiving portion 2b, of the outer receiving portion 2a and here it is held by several holding claws 28 on the main body 1, which are crimped radially inward and extend axially outward in front of the base portion 22. However other attachment means are possible too.

The inner diameter of the base portion 22 is smaller than the diameter of the further receiving portion 2b so that it radially covers the latter somewhat. It therefore extends axially on the outside in front of the annular seal 17 and supports it to avoid accidental deformation thereof. Accordingly the arrangement ensures that the seal 17 cannot be deformed so much even with a high internal pressure so far that it comes clear in the outer periphery 26 of the fluid line 12.

The support arms 23 slant from the base portion 22 in a direction opposite to the direction of insertion 32 as indicated by an arrow of the fluid line 12 axially outward, it being possible for them to protrude axially beyond the socket 2.

It is an advantage if the support arms 23 extend at least substantially parallel to the longitudinal axis 7.

Preferably the gripping teeth 24 and 25 are collected together as two tooth groups 24′ and 25′ spaced from each other in the direction of the longitudinal axis 7. The first gripping teeth 24 of the first toot group are further removed from the base portion 22 axially than the second gripping teeth 25 belonging to the second tooth group 25′.

However it is an advantage if the gripping teeth 24 or 25 belonging to the same tooth group 24′ or 25′ lie at the same axial level. This is so with the working example. In principle however within the individual tooth groups 24′ and 25′ an additional axial offset could be present between the individual gripping teeth.

Each gripping tooth 24 and 25 is preferably attached by way of a resiliently elastic mounting portion 31 in a radially resilient manner on the associated support arm 23 by means of a mounting portion 33. The gripping teeth 24 and 25 are consequently in each case able to move radially in relation to the support arm 23 bearing them as indicated by the double arrows 34. The radial motion may take place as part of a small pivoting movement.

Each gripping tooth 24 and 25 is provided with an actuating portion 24a and 25a belonging to the collet 4. The actuating portion is so fashioned that the associated gripping tooth 24 or 25 is thrust radially inward toward the outer periphery 26 of the fluid line 12, when a suitably directed actuating force is applied to it. Each gripping tooth 24 and 25 is suitably kinematically coupled with its own particular actuating portion 24a and 25a and is more particularly fixedly joined to it.

Preferably the attachment portions 24a and 25a are directly formed by the above mentioned mounting portions 13. This simplifies the design of the collet 4.

The actuating portions 24a and 25a are in particular so designed that they project radially outward past the support arms 23. In the example they have a cranked configuration and more particularly a V-like structure so that there is in each case a radially outwardly directed raised portion, that is to say a ridge portion 35. This results in a radially exposed position of the actuating portions 24a and 25a standing proud of the support arms 23 so that for actuation by the actuating sleeve 5 they are quite accessible.

The actuating sleeve 5 is mounted in an axially sliding manner on the main body 1 to render possible a displacement movement 6. As compared with a screw bearing or a bayonet attachment, which would also be possible, this design leads to simpler handling and simpler manufacture. In order to clamp an inserted fluid line 12 the actuating sleeve 5 must only be axially slid out of the non-actuated position illustrated in FIG. 1 toward the interior of the socket 2 until it assumes an actuated position, in which by acting on all actuating portions 24a and 25a the gripping teeth 24 and 25 are thrust radially inward and pressed against the outer periphery 26 of the fluid line 12.

In the course of the clamping action then occurring the gripping teeth 24 and 25, which are preferably fashioned of a material harder than that of the fluid line 12, preferably bite to a minimum extent in the wall of the fluid line 12 and effectively grasp it. Accordingly the fluid line 12 is not only secured by a frictional engagement but also in an interlocking manner.

In this respect it is convenient for the gripping teeth 24 and 25 to have an oblique form slanting toward their front side directly cooperating with the fluid line 12, i. e. obliquely radially inward and simultaneously axially inwardly. The consequence of this is that the gripping teeth 24 and 25 make an enhanced gripping engagement with the fluid line 12 in a direction opposite to the direction of insertion 23, because their actuating portions 24a and 25a bear against the actuating sleeve 5.

If the inserted fluid line 12 is to be released again it is sufficient to pull back the actuating sleeve 5 into the non-actuated state. Owing to its resiliently elastic mounting portions the gripping teeth 24 and 25 then automatically move radially clear in an outward direction and release the fluid line 12.

To avoid accidental release from the actuating position of the actuating sleeve 5 detent means 36a and 36b may be present. Such detent means 36a and 36b serve to ensure in the working example a detachable detent acting between the actuating sleeve 5 unit collet 4. Preferably the collet 4 has first detent means 36a on it extending from the ridge portions 35 of the second actuating portion 25a belonging to the second gripping teeth 25, whereas as second detent means 36b detent wells 37 are present on the inner periphery of the actuating sleeve 5, into which the ridge portions 35 may fit in the actuating position of the actuating sleeve 5.

The actuated position of the actuating sleeve 5 may also be termed an actuated position, because in this case it acts in an actuating manner on the actuating portions 24a and 25a.

The axial sliding displacement of the actuating sleeve 5 takes place preferably between the same and the main body 1. In the working embodiment the actuating sleeve 5 moves coaxially into the socket 2 and is guided in a sliding manner on its inner periphery.

A radially inwardly projecting annular collar 38a on the main body 1 in the outer opening portion of the socket 2 is hooked at the rear by a radially outwardly projecting annular collar 38b on the actuating sleeve 5 so that the actuating sleeve 5 cannot be completely withdrawn from the socket 2. The non-actuated position is defined when the two annular collars 38a and 38b axially engage each other. In order to ensure that the actuating sleeve 3 may nevertheless be mounted without any problems, its longitudinal portion into the socket 2 is provided with several longitudinal slots 42 at positions distributed about its periphery, which allow a slight elastic radial deformation.

For acting on the actuating portions 24a and 25a corresponding actuating faces 24a and 25b are provided on the inner periphery of the actuating sleeve 5. Such faces each have in the working example a face portion 43 inclined in relation to the direction 6 of shifting, such face portion 43 being placed in front of the associated actuating portion 24a and 25a in the non-actuated state of the actuating sleeve 3 axially outward and furthermore a straight face portion 44 parallel to the longitudinal axis 7 and adjoining the sleeve 5 in an axially outer direction.

The inclined face portions 43 are directed obliquely axially inwardly, their distance from the longitudinal axis 7 decreasing axially in an outward direction. The radial distance of the straight face portions 44 from the longitudinal axis is essentially equal to the distance between this longitudinal axis 7 and the support arms 23.

The first and the second actuating portions 24a and 25a are offset in relation to one another according to the first and the second 24 and 25 in the direction of the longitudinal axis 7. Accordingly there are first actuating faces 24b arranged on the actuating sleeve 5 for cooperation with the first actuating portions 24a and they are axially spaced from second actuating faces 25b, which cooperate with the second actuating portions 25a.

When the actuating portions 24a and, respectively, 25a belonging to a respective tooth group 24′ and 25′ are at the same level axially, the associated actuating faces 24b and 25b may be formed in principle by portions of an annular face extending on the inner periphery of the actuating sleeve 5 and centered on the longitudinal axis 7. However it is preferable in accordance with the working embodiment to provide each actuating portion 24a and 25a with its own actuating face 24b and 25b.

In the particular embodiment this is ensured because for each actuating portion 24a and 25a there is a guide groove 45 extending axially on the inner periphery of the actuating sleeve 5, into and along which the associated actuating portion 24a and 25a slides on axial displacement of the actuating sleeve 5 and whose floor constitutes the respective actuating face 24b and 25b. Owing to the engagement of the actuating portions 24a and 25a in the guide grooves 45 there is furthermore a means preventing turning of the actuating sleeve 5 in relation to the collet 4, something which results in prevention of rotation in relation to the main body 1, when the collet 4 is secured to the main body 1 in a manner avoiding relative turning.

It is an advantage, when the actuating sleeve 5 is in the non-actuated position, for the first actuating faces 24b to be arranged at a greater distance “x” from the first actuating portions 24a associated with them than the axial distance “y” between the second actuating faces 25b and the second actuating portions 25a associated with them. The consequence of this is that on actuation of the actuating sleeve 5 there is no simultaneous actuation of all gripping teeth 24 and 25 but rather an actuation at different times, i. e. in sequence. In the particular example the actuating sleeve 5 acts, owing to the smaller axial distance of “y” firstly on the second actuating portions 25a and then just after this on the first actuating portions 24a. Accordingly the maximum actuating force necessary for the actuation of the first gripping teeth 24 (in the first tooth group 24′) only has to be applied after the second gripping teeth 25 have already undergone maximum deformation. Generally the effect of this is that for the actuation of all gripping teeth 24 and 25 a lower actuation force has to be applied to the actuating sleeve 5 than when all gripping teeth 24 and 25 are simultaneously actuated. Despite having a large number of gripping teeth 24 and 25 in this case the coupling device 10 may be operated with less force being applied.

It is to be observed that the above mentioned different axial spacing is not necessarily limited to two tooth groups. In principle a configuration would be possible such that the gripping teeth 24 and 25 present would be actuated one after the other so that the necessary would be optimally distributed.

The necessary actuating force is only to be applied in the working example until the inclined portions 43 of the actuating faces 24b and 25b have moved over the associated actuating portions 24a and 25a. Once an actuating portion 24a and 25a is located radially within a straight face portion 44, then in this respect no further axial shifting force need be applied. To this extent the designed must be such that at least some actuating portions 24a or 25a are removed some distance from the straight face portions 44 associated with them, when other actuating portions 24a and 25a have already arrived in the vicinity of the straight face portions 44 associated with them.

At least some and preferably all support arms 23 preferably have in each case at least two axially spaced gripping teeth 24 and 25. A design with just two gripping teeth 24 and 25 per support arm 23 has been shown to be best as regards simplicity of manufacture and satisfactory function. In accordance with the working example on each support arm 23 a gripping tooth 24, belonging to the first tooth group 24′, with an associated first actuating portion 24a may be provided and furthermore also a second gripping tooth 25, belonging to the second group 25′, including the second actuating portion 25a allotted thereto.

Preferably the first gripping teeth 24 are arranged as an axial extension of the respective support arm 23 bearing them at its free end, in particular with the intermediate positioning of the associated actuating portion 24a. The second gripping tooth 25 is seated axially between the first gripping tooth 24 and the base portion 22, but however is preferably arranged laterally on the support arm 23 so that in the peripheral direction, indicated by a double arrow, of the collet 4 there is a certain offset of the first and second gripping teeth 24 and 25 positioned on one and the same support arm 23.

The laterally arranged second gripping tooth 25 is in this case more particularly secured on the side of the support arm 23 by means of a connecting rib 46 extending in the above mentioned peripheral direction 46. The connecting rib 47 allows a relatively large transverse spacing of the second gripping tooth 25 from the support arm 23 to be maintained so that, as considered in the axial direction in accordance with FIG. 4, there is only a small degree of covering over from the side or in some cases no covering over of the first and second gripping teeth 24 and 25 arranged on the same support arm 23.

Owing to the connecting rib 47 it is more particularly possible for such a transverse spacing or distance of the second gripping tooth 25 to be set that the gripping tooth 25 assumes a position exactly in the middle between the two first gripping teeth 24 in front of it, of which one belongs to the same support arm 23 and the other belongs to the adjacent support arm 23.

As shown in FIG. 4 without any mutual obstruction of the gripping teeth 24 and 25 in this manner it is possible to arrange for an engagement right the way around the inserted fluid line 12.

The second gripping tooth 25 is held on the respective connecting rib 47 in particular with the intermediate placement of the associated actuating portion 25a.

The collet 4 is preferably in particular in the form of an integral stamped and bent component of metal. FIG. 6 shows the collet 4 in the sheet metal part in the working embodiment as the collet 4 prior to bending and just as stamped from flat material. It will be seen that here inter alia there is the annular base portion 22, which preferably is circumferentially complete and not interrupted in order to ensure an optimum supporting action for the seal 17. The bracing or clamping function as explained of the collet 4 would however also be possible with a base portion 22 slotted at some point on its periphery.

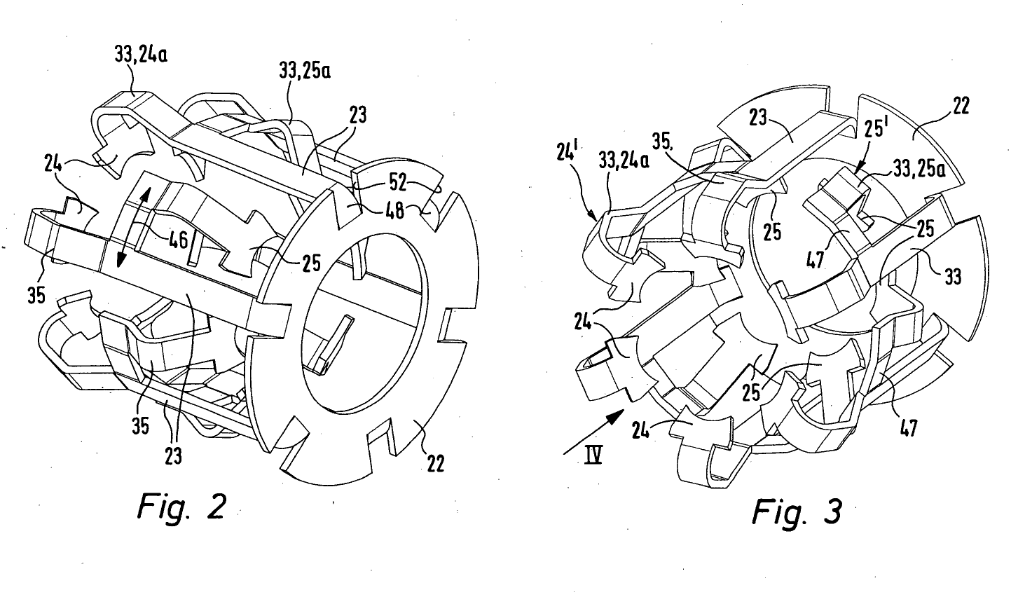

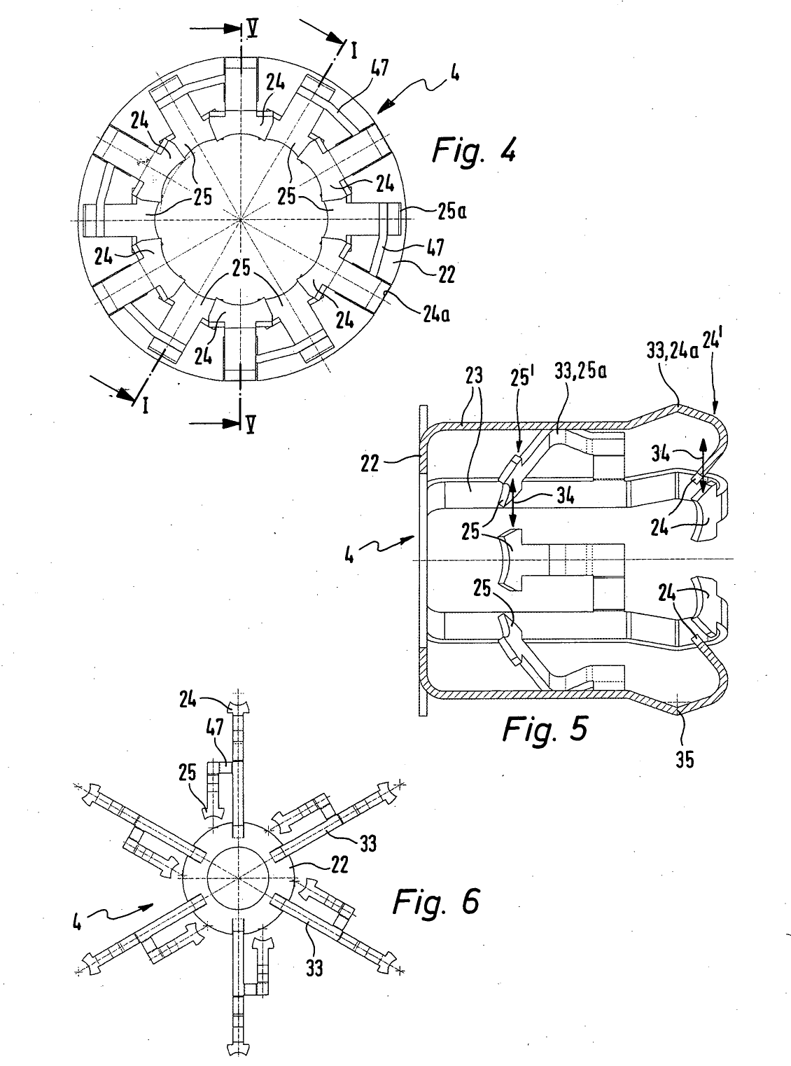

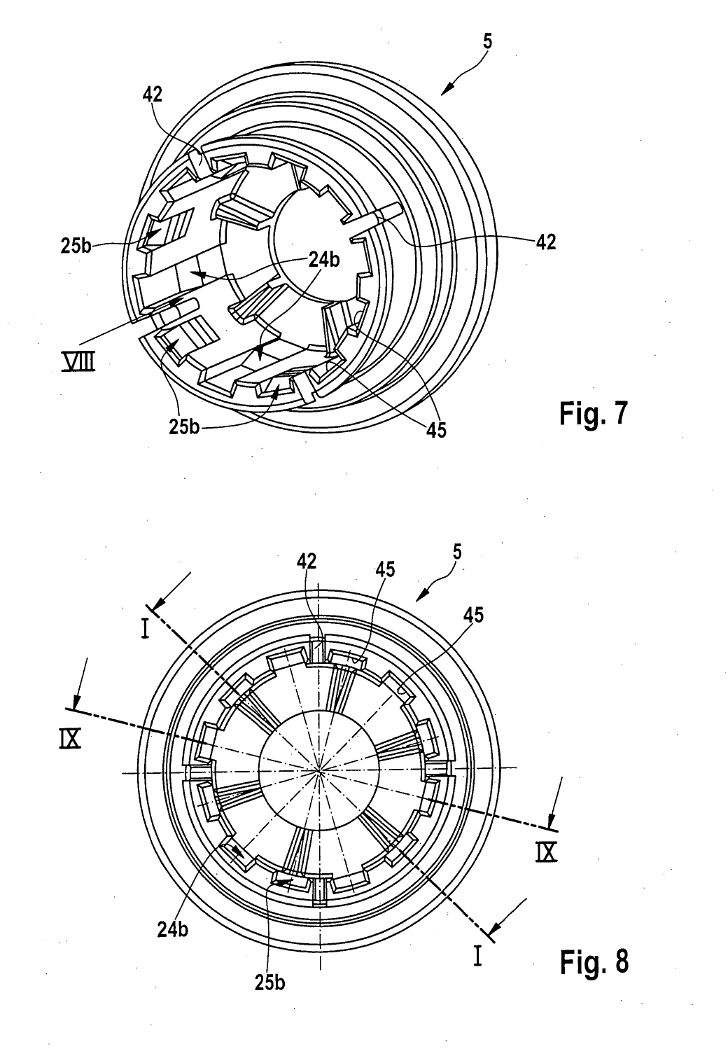

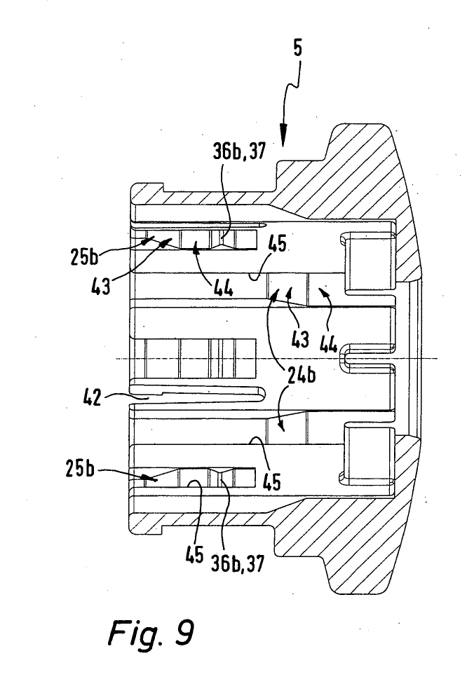

FIG. 2 indicates that the base portion 22 in the form of an annular disk has a respective window 52 at the foot portions, extending from this point, of the curved support arms 23. When axially offset gripping teeth 24 and 25 are respectively arranged on one and the same support arm 23, a relatively large number of gripping teeth 24 and 25 may be produced with a relatively small number of support arms 23 so that the number of windows 52 remains low. This improves the supporting action for the seal 17.

It is also to be mentioned that the first and second actuating portions 24a and 25a arranged on first and the same support arm 23 preferably point in opposite directions. The first actuating portions 24a extend from the support arm 23 toward the side opposite to the base portion 22, whereas the second actuating portions 25a extend from the connecting rib 47 carrying them toward the base portion 22.

The main body 1 preferably consists of metal and in particular of aluminum material. The actuating sleeve 5 is more particularly in the form of a plastic component or a precision casting of stainless steel.

1. A coupling device for a fluid line comprising a sleeve-like collet bearing against a main body axially and into which a fluid line to be coupled may be coaxially inserted and which has a plurality of and axially extending support arms distributed in the peripheral direction, of which at least some bear at least two axially spaced radially inwardly extending gripping teeth, which on axial shifting of a actuating sleeve arranged around the collet may be thrust radially inward to perform a coupling operation in order to be braced against the outer periphery of the inserted fluid line, characterized in that the collet possesses an annular base portion from which all support arms extend in the same axial direction, all gripping teeth being spaced axially from and in front of the base portion, and each gripping tooth on the collet being provided with its own actuating portion individually, on which the actuating sleeve may act during its axial shifting movement to cause the respective coupling action of the respective gripping tooth, the actuating sleeve for operation of the actuating portions of axially spaced apart gripping teeth being provided with actuating faces arranged at an axial distance apart.

2. The coupling device as set forth in claim 1, characterized in that each gripping tooth is attached on the associated support arm in a radially resiliently elastic manner by an individually associated mounting portion.

3. The coupling device as set forth in claim 2, characterized in that the actuating portions are formed by the mounting portions.

4. The coupling device as set forth in claim 1, characterized in that the actuating portions project radially outward beyond the support arms.

5. The coupling device as set forth in claim 1, characterized in that the actuating portions have a cranked configuration with a radially outwardly orientated ridge portion.

6. The coupling device as set forth in claim 1, characterized in that the actuating sleeve is able to be shifted axially in relation to the collet, detent means being present on the collet and on the actuating sleeve which produce a releasable catch action between the collet and the actuating sleeve when the latter is pushed into an actuated position concluding the bracing action.

7. The coupling device as set forth in claim 6, characterized in that the actuating portions have a cranked configuration with a radially outwardly orientated ridge portion and that the detent means include detent wells arranged on the inner periphery of the actuating sleeve, such wells cooperating with detent projections formed by the ridge portions of the actuating portions.

8. The coupling device as set forth in claim 1, characterized in that the collet is so arranged on the main body that the support arms, starting from the base portion extend axially outwardly in a direction opposite to the insertion direction of the fluid line.

9. The coupling device as set forth in claim 8, characterized in that the collet has at least its base portion arranged in a socket in the main body communicating with a fluid duct.

10. The coupling device as set forth in claim 9, characterized in that the base portion axially supports a coaxial seal ring, such ring being arranged in the main body on the side of the base portion which is on the side axially opposite to the support arms.

11. The coupling device as set forth in claim 1, characterized in that the collet has its base portion axially secured to the main body.

12. The coupling device as set forth in claim 1, characterized in that the actuating sleeve is mounted on the main body in an axially sliding fashion.

13. The coupling device as set forth in claim 1, characterized in that each support arm bears at least two gripping teeth spaced apart in the longitudinal direction of the collet.

14. The coupling device as set forth in claim 1, characterized in that the gripping teeth borne on the same support arm are arranged with a mutual offset in the peripheral direction of the collet.

15. The coupling device as set forth in claim 14, characterized in that a front gripping tooth is arranged on the free end of the support arm as an axial extension thereof, while at least one further gripping tooth is arranged between the front gripping tooth and the base portion laterally on the support arm.

16. The coupling device as set forth in claim 15, characterized in that the further gripping tooth is arranged by means of a connecting rib on the support arm, such rib extending in the peripheral direction of the collet.

17. The coupling device as set forth in claim 1, characterized in that the gripping teeth arranged with an axial spacing on the support arms form at least two groups of gripping teeth spaced at different distances from the base portion, the gripping teeth belonging to the same group being arranged with the same distance from the base portion.

18. The coupling device as set forth in claim 1, characterized in that in the non-actuated position of the actuating sleeve the actuating portions of the gripping teeth provided on the collet and the actuating faces associated with same on the actuating sleeve are at least partly so differently spaced apart in the displacement direction of the actuating sleeve that on actuation of the actuating sleeve several actuating portions are operated in a timed sequence.

19. The coupling device as set forth in claim 18, characterized in that the gripping teeth arranged with an axial spacing on the support arms form at least two groups of gripping teeth spaced at different distances from the base portion, the gripping teeth belonging to the same group being arranged with the same distance from the base portion, wherein the axial distance apart between the actuating portions and the actuating faces is such that the gripping teeth of the two tooth groups are actuated one after the other, the gripping teeth belonging to the same group each being simultaneously actuated.

20. The coupling device as set forth in claim 1, characterized in that for each actuating portion there is a particular actuating face individually provided and arranged on the actuating sleeve.

21. The coupling device as set forth in claim 20, characterized in that for each actuating portion there is an axially extending guide groove on the inner periphery of the actuating sleeve and on axial displacement of the actuating sleeve the associated actuating portion slides along and in such groove, the floor of the groove constituting the actuating face.

22. The coupling device as set forth in claim 1, characterized in that the actuating faces have face portions which are inclined in relation to the displacement direction of the actuating sleeve.

23. The coupling device as set forth in claim 22, characterized in that a straight face portion of the actuating face, which is parallel to the direction of displacement, adjoins each inclined face portion.

24. The coupling device as set forth in claim 1, characterized in that the collet is designed in the form of a stamped and bent metal component.

25. The coupling device as set forth in claim 1, characterized in that the main body is constituted by an individual component provided with attachment means or by the wall of a fluid power device.
